(19) United States
(12) Patent Application Publication
(10) Pub. No.: US 2025/0315272 A1
(43) Pub. Date: Oct. 9, 2025

(54) CONTACT CONFIGURATION INCLUDING EXTRACTED CONTEXT DATA

(71) Applicant: Motorola Mobility LLC, Chicago, IL (US)

(72) Inventors: Amit Kumar Agrawal, Bangalore (IN); Krishnan Raghavan, Bangalore (IN); Hariprasad Shanbhogue Alampady, Bangalore (IN)

(73) Assignee: Motorola Mobility LLC, Chicago, IL (US)

(21) Appl. No.: 18/625,475

(22) Filed: Apr. 3, 2024

(51) Int. Cl. G06F 9/445; G06F 16/9535

(52) U.S. Cl. CPC G06F 9/4451; G06F 16/9535

(57) ABSTRACT

Techniques for contact configuration including extracted context data are described. For instance, the described techniques can be implemented to detect a contact data trigger to perform a contact operation and extract context data pertaining to one or more of the contact data trigger or the contact operation. The context data, for instance, includes an indication of a contextual relationship between a user of the client device and a contact associated with the contact operation. A contact recommendation is generated based at least in part on the context data, and a contact profile is configured based at least in part on the contact recommendation.

### BACKGROUND

In today's connected environment a user typically interacts with a wide variety of other users and in a variety of different contexts. For instance, a user may utilize a mobile device to engage in text messaging, phone calls, video meetings, etc., with other users. To assist in keeping track of other users, the user may generate contact profiles (“contacts”) for the users such as to track user information including names, phone numbers, emails, etc. While the ability to track contacts can be convenient, a number of contacts can become overwhelming such that a user may be unable to locate a desired contact and/or a particular contact may lose “meaning” to the user, e.g., the user may not remember who the contact is and/or why the contact was generated in the first place.

### BRIEF DESCRIPTION OF THE DRAWINGS

Aspects of contact configuration including extracted context data are described with reference to the following Figures. The same numbers may be used throughout to reference similar features and components that are shown in the Figures. Further, identical numbers followed by different letters reference different instances of features and components described herein:

FIG. 1 illustrates an example environment 100 in which aspects of contact configuration including extracted context data can be implemented.

FIG. 2 illustrates an example scenario 200 for contact configuration including extracted context data in accordance with one or more implementations.

FIG. 3 illustrates an example scenario 300 for contact configuration including extracted context data in accordance with one or more implementations.

FIG. 4 illustrates an example scenario 400 for contact configuration including extracted context data in accordance with one or more implementations.

FIG. 5 illustrates an example scenario 500 for contact configuration including extracted context data in accordance with one or more implementations.

FIG. 6 illustrates an example scenario 600 for contact configuration including extracted context data in accordance with one or more implementations.

FIG. 7 illustrates an example scenario 700 for contact configuration including extracted context data in accordance with one or more implementations.

FIG. 8 illustrates an example scenario 800 for contact configuration including extracted context data in accordance with one or more implementations.

FIG. 9 illustrates a flow chart depicting an example method 900 for contact configuration including extracted context data in accordance with one or more implementations.

FIG. 10 illustrates a flow chart depicting an example method 1000 for contact configuration including extracted context data in accordance with one or more implementations.

FIG. 11 illustrates various components of an example device 1100 in which aspects of contact configuration including extracted context data can be implemented.

### DETAILED DESCRIPTION

Techniques for contact configuration including extracted context data are described. For instance, the described techniques can be implemented to generate contact profiles for contacts to include context data. The context data, for instance, can include data pertaining to why, when, and/or where a particular contact profile was generated. Context data included as part of a contact profile can enable a user to differentiate contacts from one another and reduce confusion around instances of large collections of contacts.

For instance, consider a scenario where a user receives a text message from a different user as part of a text conversation. Further, the different user may include context information in the text message, such as relationship information between the different user and the user, location information (e.g., where the user and the different user met, a destination to which the user and different user are traveling, etc.), message intent information such as a reason and/or request associated with the text conversation, etc.

Accordingly, the described techniques can extract the context information and generate a contact recommendation to configure a contact profile to include at least some of the context information. Configuring the contact profile, for instance, can include generating a new contact profile for the different user and/or updating an existing contact profile for the different user. Thus, the contact profile can include information such as user name, phone number, email, etc., as well as the context information. This can assist the user in remembering “why” the contact profile was generated and/or updated, as well as in differentiating the contact profile from other contact profiles.

Thus, techniques described herein enable efficient and accurate configurating of contact profiles to include context information, which can provide a richer contact representation than is provided by conventional contact profile representations.

While features and concepts of contact configuration including extracted context data can be implemented in any number of environments and/or configurations, aspects the described techniques are described in the context of the following example systems, devices, and methods. Further, the systems, devices, and methods described herein are interchangeable in various ways to provide for a wide variety of implementations and operational scenarios.

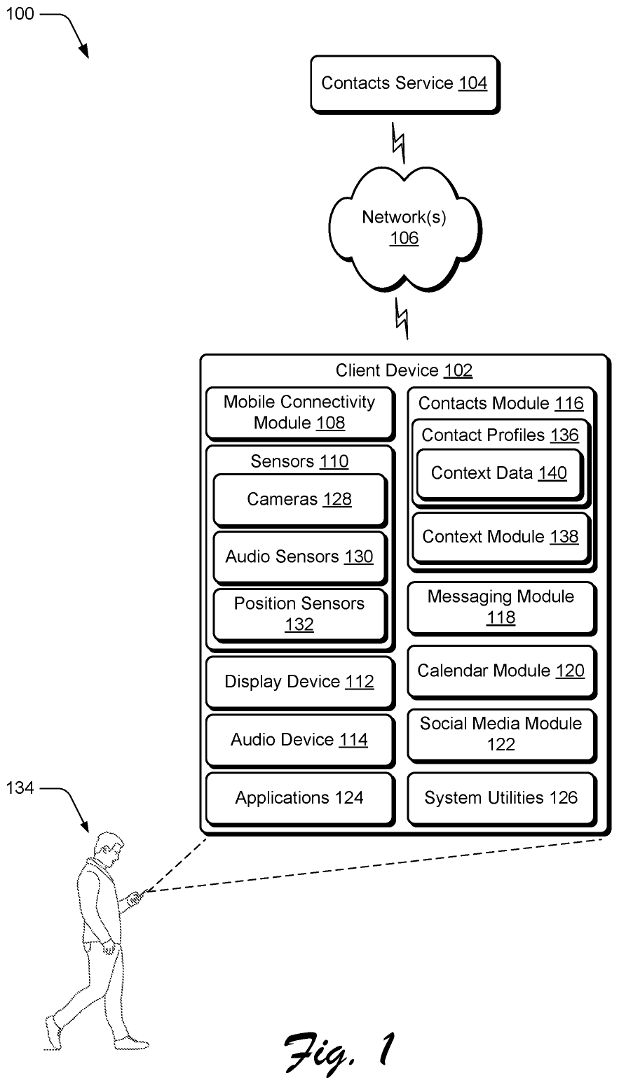

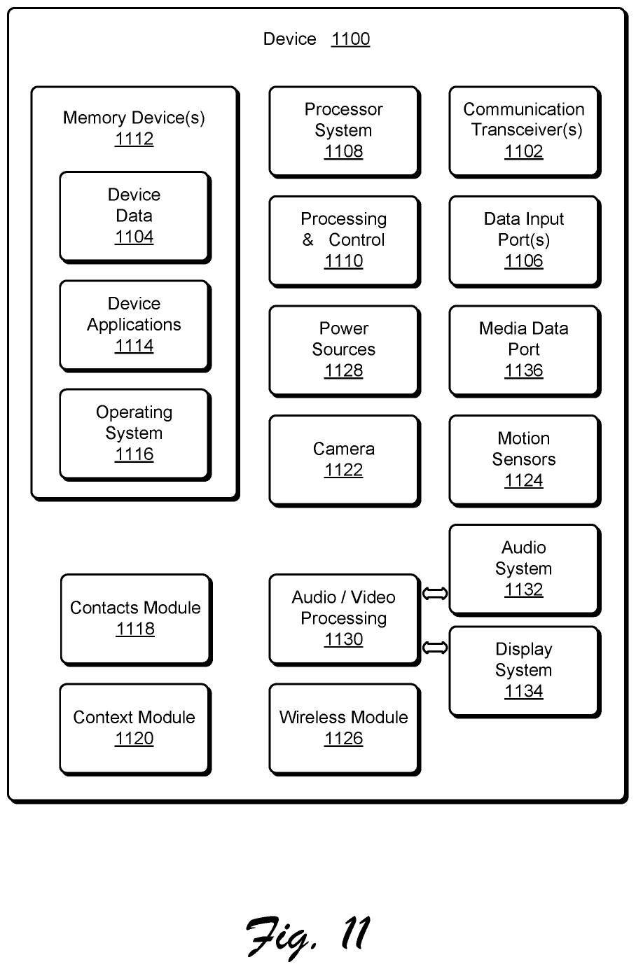

FIG. 1 illustrates an example environment 100 in which aspects of contact configuration including extracted context data can be implemented. The environment 100 includes a client device 102 and a contacts service 104 that are interconnectable via network(s) 106. The client device 102 can be implemented in various ways such as a mobile phone, a wearable device, a tablet device, a laptop, an extended reality (XR) device, and so forth. Example attributes and implementations of the client device 102 are discussed below with reference to the device 1100 of FIG. 11.

The client device 102 includes various functionality that enables the client device 102 to perform different aspects of contact configuration including extracted context data discussed herein, including a mobile connectivity module 108, sensors 110, display device 112, audio device 114, a contacts module 116, a messaging module 118, a calendar module 120, and a social media module 122. In at least some implementations one or more of the contacts module 116, messaging module 118, calendar module 120, and/or social media module 122 can represent instances of applications 124, instances of system utilities 126 of the client device 102, and/or other implementations of functionality accessible via the client device 102. The mobile connectivity module 108 represents functionality (e.g., logic and hardware) for enabling the client device 102 to interconnect with other devices and/or networks, such as the network 106. The mobile connectivity module 108, for instance, enables wireless and/or wired connectivity of the client device 102.

The sensors 110 are representative of functionality to detect various physical and/or logical phenomena in relation to the client device 102, such as motion, light, image detection and recognition, time and date, position, location, touch detection, sound, temperature, and so forth. Examples of the sensors 110 include hardware and/or logical sensors such as an accelerometer, a gyroscope, a camera, a microphone, a clock, biometric sensors, touch input sensors, position sensors, environmental sensors (e.g., for temperature, pressure, humidity, and so on), geographical location information sensors (e.g., Global Positioning System (GPS) functionality), and so forth. In this particular example the sensors 110 include cameras 128, audio sensors 130, and position sensors 132. The sensors 110, however, can include a variety of other sensor types in accordance with the implementations discussed herein.

The display device 112 represents functionality for outputting visual content via the client device 102 and the audio device 114 represents functionality for outputting audio content for the client device 102.

The contacts module 116 represents functionality for tracking and storing data for different persons associated with a user 134 of the client device 102. The contacts module 116, for example, includes contact profiles 136 and a context module 138. The contact profiles 136 represent data about different contacts, such as names, identifiers, phone numbers, email addresses, physical addresses, social media identifiers, etc. The context module 138 represents functionality for determining and/or extracting context information for different contact profiles 136. For example, for instances of the contact profiles 136, the context module 138 can obtain (e.g., extract, receive, request, etc.) context information which can be stored as context data 140 for instances of the contact profiles 136. The context module 138, for instance, can obtain the context data 140 from various functionality of the client device 102, such as the messaging module 118, the calendar module 120, the social media module 122, applications 124, system utilities 126, the mobile connectivity module 108, the sensors 110, etc. According to implementations the contacts module 116 and the context module 138 represent functionality for performing various aspects of contact configuration including extracted context data described herein.

The messaging module 118 represents functionality for enabling various types of messaging via the client device 102, such as text messaging, media messaging (e.g., audio messaging, video messaging, etc.), content-based messaging, and so forth. The calendar module 120 represents functionality for storing and tracking different time and date based events such as for the user 134. For example, the user 134 can utilize the calendar module 120 to generate and/or accept different calendar events which can be stored by the calendar module 120. The social media module 122 represents functionality for enabling the user 134 to utilize the client device 102 to engage in social media interactions with other users, such as posting social media content to social media platforms, consuming social media content from social media platforms, etc.

The applications 124 represent functionality for performing different computing tasks via the client device 102, such as web browsing, messaging, gaming, media consumption (e.g., content streaming), productivity tasks (e.g., email, calendar management, word processing, content generation, data analysis, etc.), content generation, communication with other devices, and so forth.

The contacts service 104 represents a network-based service that can implement various aspects of contact configuration including extracted context data described herein. For instance, the contacts module 116 can interface with the contacts service 104 via the network 106 to enable various contacts-related operations, such as generating new contact profiles 136, updating existing contact profiles 136, etc.

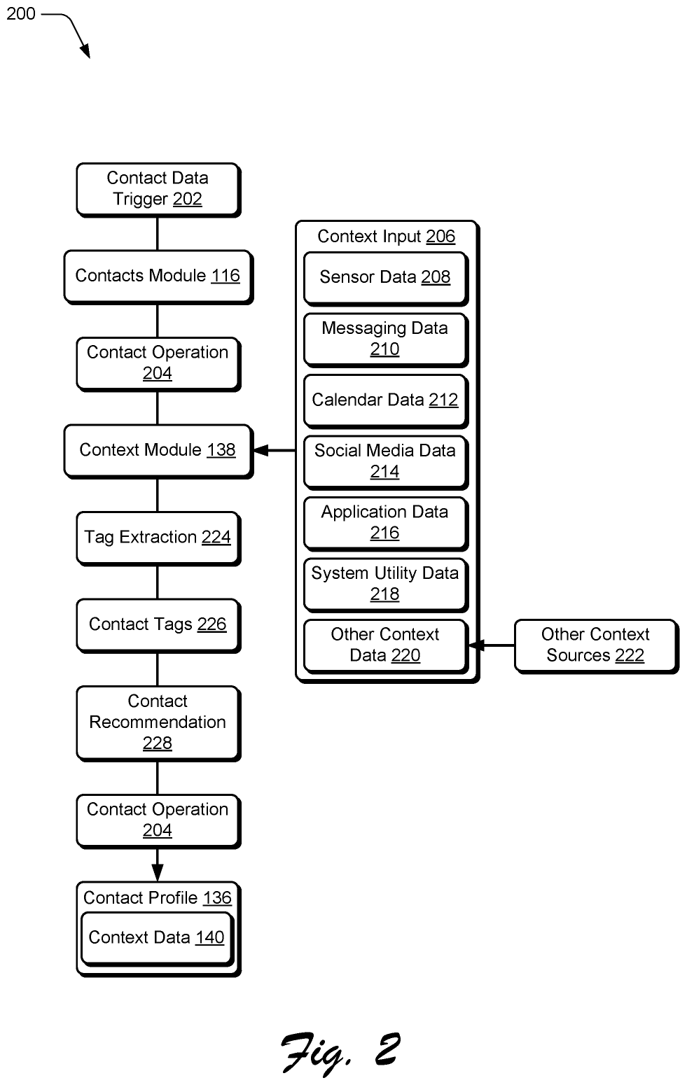

FIG. 2 illustrates an example scenario 200 for contact configuration including extracted context data in accordance with one or more implementations. In the scenario 200 a contact data trigger 202 occurs that causes the contacts module 116 to initiate a contact operation 204. The contact operation 204 can include various contact-related operations such as generating new contact profiles 136, updating existing contact profiles 136, etc. Further, the contact data trigger 202 can occur in response to different events such as the user 134 providing input to generate a new contact profile 136, input to update an existing contact profile 136, etc.

Based at least in part on the contact data trigger 202 and initiation of the contact operation 204, the context module 138 receives context input 206. The context input 206, for instance, represents data that pertains to an instance of a contact profile 136. Further, the context input 206 can be obtained by the contacts module context module 138 in various ways, such as based on a query by the context module 138 for context data, a push notification to the context module 138 from other functionality including the context input 206, etc. Examples of the context input 206 include:

Sensor data 208 generated by the sensors 110: Instances of the sensors 110, for instance, can generate sensor data 208 and provide the sensor data 208 to the contacts module 116.

Messaging data 210 generated by the messaging module 118: The messaging module 118, for example, can generate context input 206 such as based on messaging interactions associated with contact profiles 136. Examples of the messaging data 210 include text, voice, images, video, etc.

Calendar data 212 generated by the calendar module 120: The calendar module 120 can generate the calendar data 212 such as based on calendar events that are linked and/or associated with instances of contact profiles 136.

Social media data 214 generated by the social media module 122: The social media module 122, for instance, can generate social media data 214 such as based on social media interactions detected from instances of contact profiles 136.

Application data 216 generated by the applications 124: The applications 124, for example, can generate the application data 216 based on application context detected as being associated with instances of the contact profiles 136.

System utility data 218 generated by the system utilities 126: The system utilities 126, for example, can generate the system utility data 218 based on system utility context detected as being associated with instances of the contact profiles 136.

Other context data 220 generated by other context sources 222: The other context sources 222, for instance, can generate other context data 220 and provide the other context data 220 to the contacts module 116.

Accordingly, the context module 138 utilizes the context input 206 to perform tag extraction 224 and generate contact tags 226 as part of a contact recommendation 228 for the contact operation 204. To perform the tag extraction 224, for instance, the context module 138 can perform keyword extraction on the context input 206 to extract various information associated with contact profiles 136 and generate the contact tags 226, such as contact names, names of persons associated with contact profiles 136, contact locations, phone numbers, email addresses, events (e.g., calendar events), contact relationships (e.g., family relationships, work relationships, social relationships, etc.), etc.

According to implementations the contacts module 116 can generate the contact recommendation 228 as a recommendation to use one or more of the contact tags 226 to configure a contact profile 136. The contact recommendation 228 can represent a recommendation to configure the contact profile 136 as a new contact profile 136 and/or an update an existing contact profile 136. The user 134 can accept the contact recommendation 228 which causes the contact operation 204 to be executed based at least in part on the contact tags 226 to configure the contact profile 136. The contact profile 136, for instance, represents a newly generated contact profile 136 and/or an updated existing contact profile 136. Further, the contact profile 136 includes context data 140 that describes various attributes of the contact profile 136. In at least one implementation the context data 140 is generated based on the contact tags 226 extracted from the context input 206.

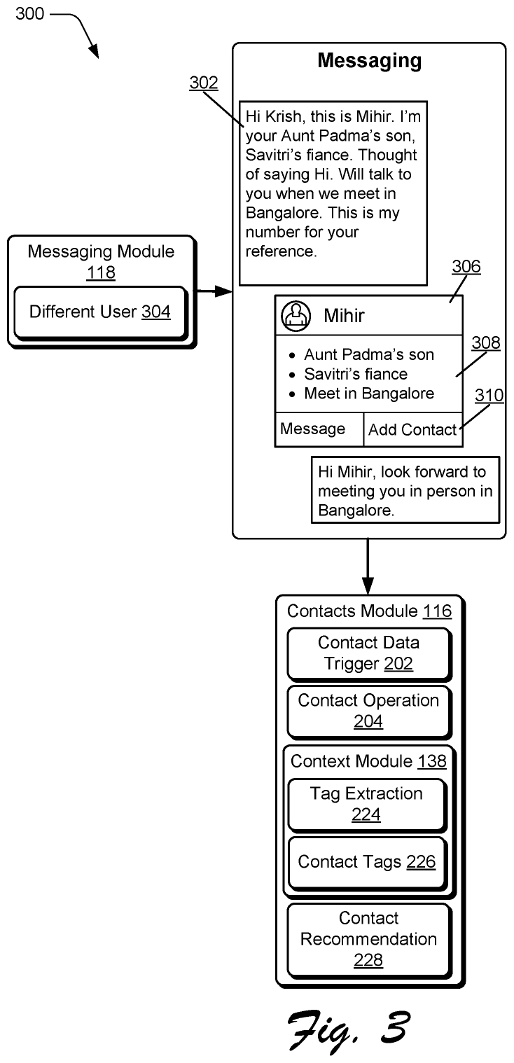

FIG. 3 illustrates an example scenario 300 for contact configuration including extracted context data in accordance with one or more implementations. In the scenario 300 a contact data trigger 202 occurs, examples of which are discussed above. In this particular example the contact data trigger 202 occurs in the context of a messaging interaction via the messaging module 118. For instance, the user 134 receives a message 302 from a different user 304 via the messaging module 118, and the message 302 includes various information pertaining to the different user 304.

Based at least in part on the contact data trigger 202 the contacts module 116 initiates a contact operation 204 to generate a contact recommendation 228 based at least in part on the message 302. As part of the contact operation 204 the context module 138 performs tag extraction 224 on the message 302 to generate contact tags 226. The contact tags 226, for instance, represent different context information extracted from the message 302. Accordingly, the contacts module 116 generates and outputs a contact option 306 that is operable to receive user interaction to generate and/or update a contact profile based on the message 302. The contact option 306, for instance, includes a suggested contact name (“Mihir”) and suggested context information 308 based on the contact tags 226. The context information 308, for instance, includes personal relationship information (e.g., “Aunt Padma's son,” “Savitri's fiancé”) and location-related information, e.g., “Meet in Bangalore.”

The contact option 306 further includes an add contact control 310 that is selectable to add a contact profile 136 for the different user 304. For instance, selecting the add contact control 310 causes a contact recommendation 228 to be generated for the different user 304, such as discussed below.

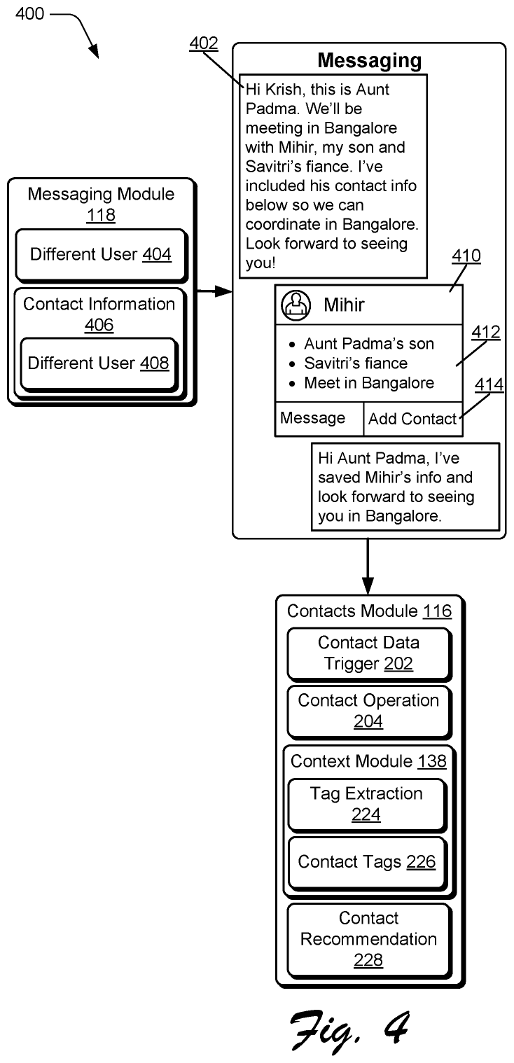

FIG. 4 illustrates an example scenario 400 for contact configuration including extracted context data in accordance with one or more implementations. The scenario 400, for instance, represents an alternative or additional scenario to the scenario 300. In the scenario 400 a contact data trigger 202 occurs, examples of which are discussed above. In this particular example the contact data trigger 202 occurs in the context of a messaging interaction via the messaging module 118. For instance, the user 134 receives a message 402 from a different user 404 via the messaging module 118, and the message 402 includes various information pertaining to the different user 404. Further, in conjunction with sending the message 402, the different user 404 shares contact information 406 for a different user 408. The different user 404 that sends the message 402, for example, is Aunt Padma, Mihir's mother as mentioned above, and the different user 408 is Mihir.

Based at least in part on the contact data trigger 202 and the contact information 406, the contacts module 116 initiates a contact operation 204 to generate a contact recommendation 228 based at least in part on the message 402. As part of the contact operation 204 the context module 138 performs tag extraction 224 on the message 402 to generate contact tags 226. The contact tags 226, for instance, represent different context information extracted from the message 402. Further, the contacts module 116 detects the shared contact information 406 and determines that a contact recommendation 228 is to be generated for the different user 408, e.g., instead of the different user 404 that sent the message 402.

Accordingly, the contacts module 116 generates and outputs a contact option 410 that is operable to receive user interaction to generate and/or update a contact profile based on the message 402 and the contact information 406. The contact option 410, for instance, includes a suggested contact name (“Mihir”) and suggested context information 412 based on the contact tags 226. The context information 412, for instance, includes personal relationship information (e.g., “Aunt Padma's son,” “Savitri's fiancé”) and location-related information, e.g., “Meet in Bangalore.”

The contact option 410 further includes an add contact control 414 that is selectable to add a contact profile 136 for the different user 408. For instance, selecting the add contact control 414 causes a contact recommendation 228 to be generated for the different user 408, such as discussed below.

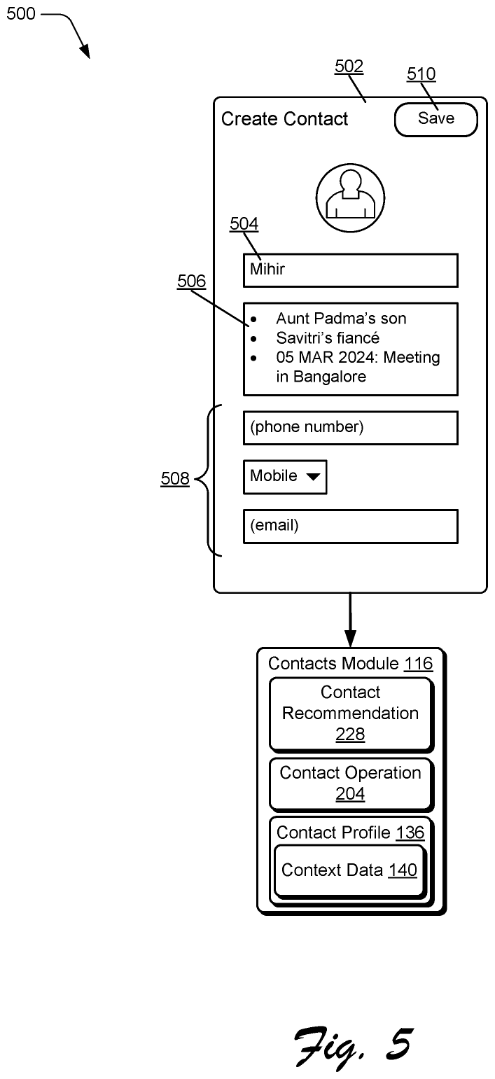

FIG. 5 illustrates an example scenario 500 for contact configuration including extracted context data in accordance with one or more implementations. The scenario 500, for instance, represents a continuation of one or more of the scenarios 300, 400. In the scenario 500 the contacts module 116 outputs a contact recommendation graphical user interface (GUI) 502 based on the contact recommendation 228. The contact recommendation GUI 502 includes various information fields for generating a contact profile 136 including a contact name field 504, a context field 506, and other contact information fields 508. According to implementations instances of the different information fields are automatically populated by the contacts module 116 based on information gathered in response to a contact data trigger 202. For instance, in this example the contacts module 118 populates the information fields with information generated by the messaging interactions described in one or more of the scenarios 300, 400. Further, the different information fields are user-editable to enable a user to customize information included in each field.

The contact name field 504 can be populated with a suggested name for the contact profile 136 and the context field 506 can be populated with context data 140 extracted by the context module 138. The context field 506, for instance, includes context data 140 extracted from one or more of the messages 302, 402, such as the context information 308 included in the contact option 306 and/or the context information 412 included in the contact option 410. In this example the context data 140 includes location information (“Meeting in Bangalore”) as well as date information, such as a date on which the location information was extracted from one or more of the messages 302, 402. The other contact information fields 508 include other extracted contact-related information such as phone numbers, emails, mailing addresses, etc. Accordingly, the user 134 can select a save control 510 to cause the contact operation 204 to be completed and the contact profile 136 to be configured (e.g., generated and/or updated) based on information included in the contact recommendation GUI 502. For instance, the contact profile 136 is configured such that information included in the contact recommendation GUI 502 is displayed as part the contact profile 136, including the context data 140 populated to the context field 506.

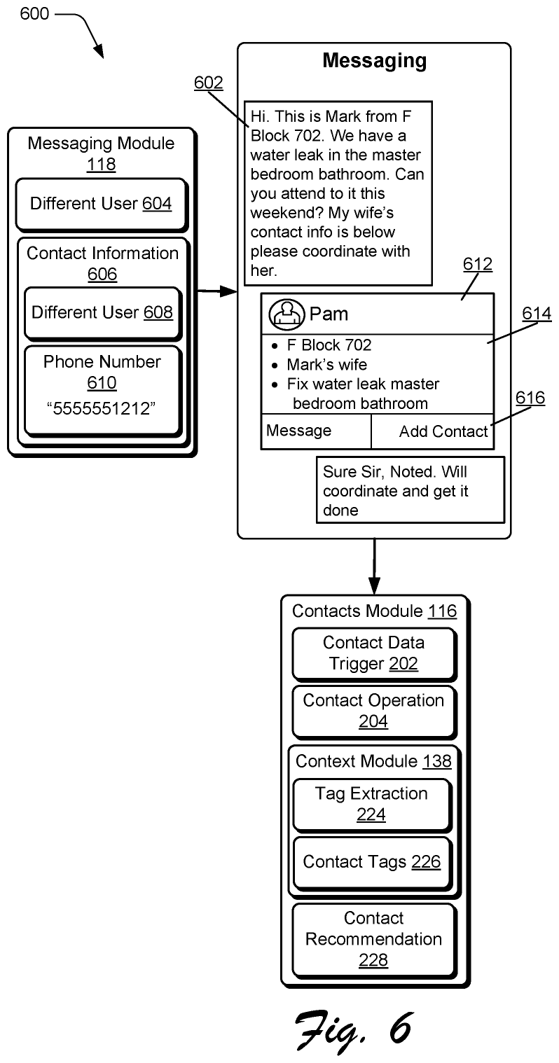

FIG. 6 illustrates an example scenario 600 for contact configuration including extracted context data in accordance with one or more implementations. In the scenario 600 a contact data trigger 202 occurs, examples of which are discussed above. In this particular example the contact data trigger 202 occurs in the context of a messaging interaction via the messaging module 118. For instance, the user 134 receives a message 602 from a different user 604 via the messaging module 118, and the message 602 includes various information pertaining to the different user 604. The message 602, for instance, represents a professional interaction including a request for a professional service at a residence. Further, in conjunction with sending the message 602, the different user 604 shares contact information 606 for a different user 608. The contact information 606 includes a phone number 610, e.g., 5555551212.

Based at least in part on the contact data trigger 202 and the contact information 606, the contacts module 116 initiates a contact operation 204 to generate a contact recommendation 228 based at least in part on the message 602. As part of the contact operation 204 the context module 138 performs tag extraction 224 on the message 602 to generate contact tags 226. The contact tags 226, for instance, represent different context information extracted from the message 602. Further, the contacts module 116 detects the shared contact information 606 and determines that a contact recommendation 228 is to be generated for the different user 608, e.g., instead of the different user 604 that sent the message 602.

Accordingly, the contacts module 116 generates and outputs a contact option 612 that is operable to receive user interaction to generate and/or update a contact profile based on the message 602 and the contact information 606. The contact option 612, for instance, includes a suggested contact name (“Pam”) and suggested context information 614 based on the contact tags 226. The context information 614, for instance, includes location information (“F Block 702”), relationship information (“Mark's wife”), and message intent information, e.g., “Fix water leak master bedroom bathroom.”

The contact option 612 further includes an add contact control 616 that is selectable to add a contact profile 136 for the different user 608. For instance, selecting the add contact control 616 causes a contact recommendation 228 to be generated for the different user 608, such as discussed below.

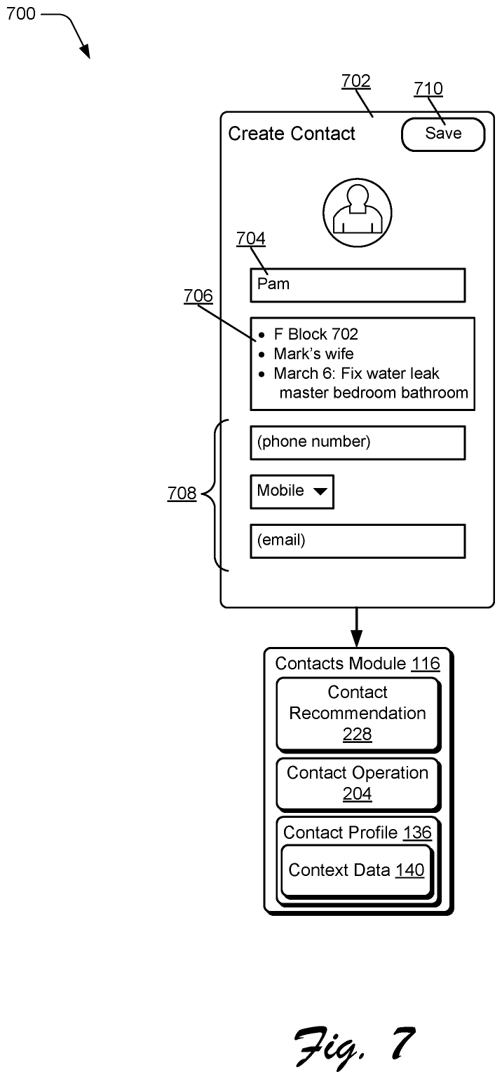

FIG. 7 illustrates an example scenario 700 for contact configuration including extracted context data in accordance with one or more implementations. The scenario 700, for instance, represents a continuation of the scenario 600. In the scenario 700 the contacts module 116 outputs a contact recommendation GUI 702 based on the contact recommendation 228. The contact recommendation GUI 702 includes various information fields for generating a contact profile 136 including a contact name field 704, a context field 706, and other contact information fields 708. According to implementations instances of the different information fields are automatically populated by the contacts module 116 based on information gathered in response to a contact data trigger 202. For instance, in this example the contacts module 118 populates the information fields with information generated by the messaging interaction described in the scenario 600. Further, the different information fields are user-editable to enable a user to customize information included in each field.

The contact name field 704 can be populated with a suggested name for the contact profile 136 and the context field 706 can be populated with context data 140 extracted by the context module 138. The context field 706, for instance, includes context data 140 extracted from the message 602, such as the context information 614 included in the contact option 612. In this example the context data 140 includes message intent information (“Fix water leak master bedroom bathroom”) as well as date information, such as a date on which the message intent information was extracted from the message 602. The other contact information fields 708 include other extracted contact-related information such as phone numbers, emails, mailing addresses, etc. Accordingly, the user 134 can select a save control 710 to cause the contact operation 204 to be completed and the contact profile 136 to be configured (e.g., generated and/or updated) based on information included in the contact recommendation GUI 702. For instance, the contact profile 136 is configured such that information included in the contact recommendation GUI 702 is displayed as part the contact profile 136, including the context data 140 populated to the context field 706.

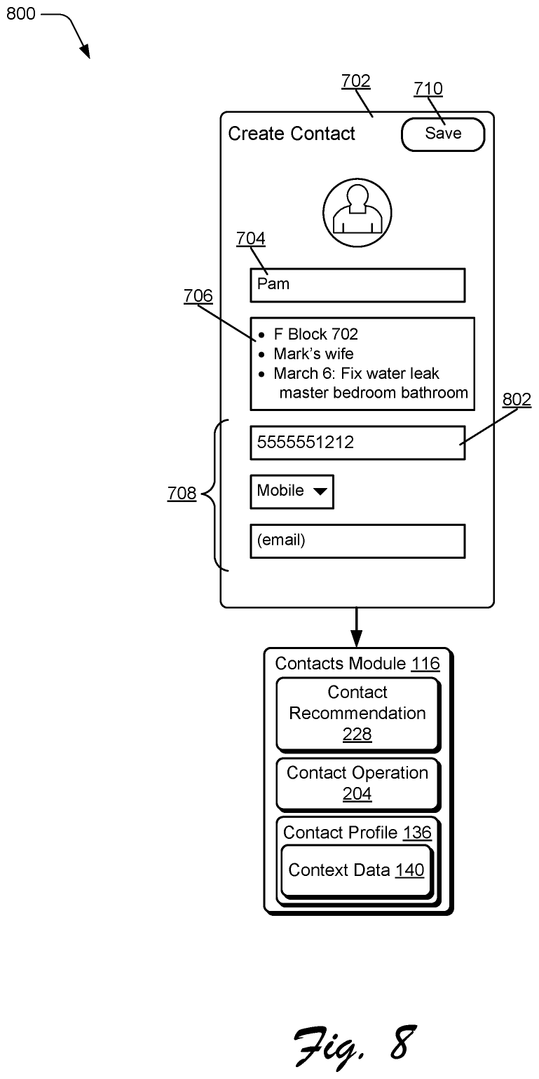

FIG. 8 illustrates an example scenario 800 for contact configuration including extracted context data in accordance with one or more implementations. The scenario 800, for instance, represents a continuation of the scenario 600 and/or an alternative or additional implementation to the scenario 700.

In the scenario 800 the user 134 initiates an action to save a contact for the phone number 610 into a phone number field 802 of the contact recommendation GUI 702, introduced above. In response to recognition of the phone number 610 in the phone number field 802, the contacts module 116 automatically generates a contact recommendation 228 based on the contact information 606 for the different user 608. For instance, the various fields of the contact recommendation GUI 702 can be automatically populated with information pertaining to the different user 608, including the context field 706 populated with context data 140 extracted by the context module 138 as described above. Accordingly, the user 134 can select the save control 710 to cause the contact operation 204 to be completed and the contact profile 136 to be configured (e.g., generated and/or updated) based on information included in the contact recommendation GUI 702. In implementations, for instance, the contacts module 116 can automatically detect the user action to generate a contact using the phone number 610, and can cause context information for the different user 608 to be automatically extracted and utilized to generate the contact recommendation 228.

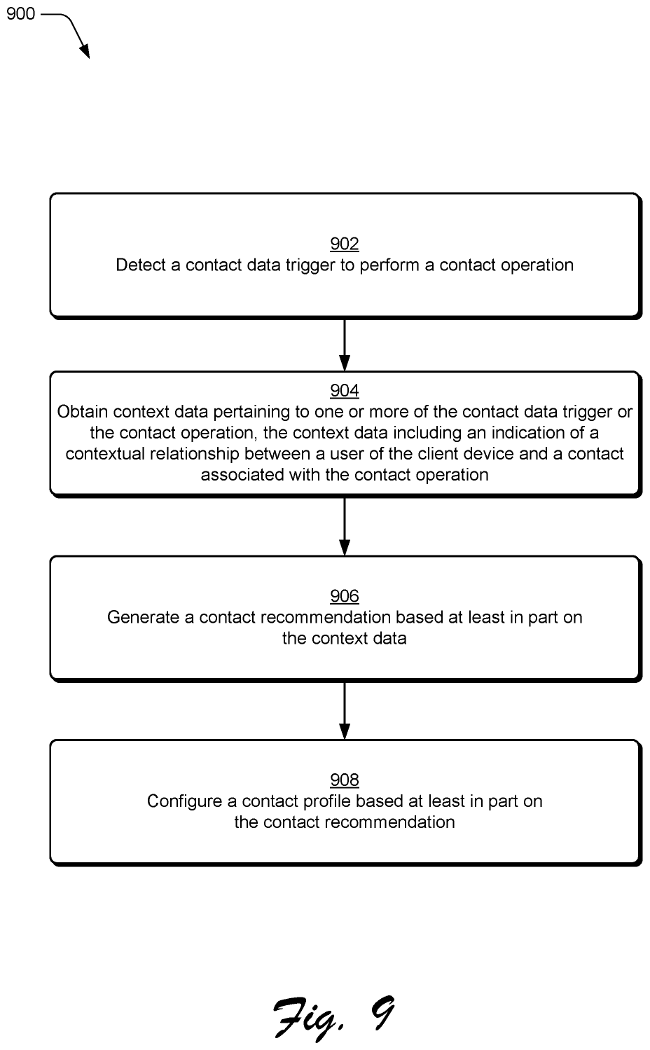

FIG. 9 illustrates a flow chart depicting an example method 900 for contact configuration including extracted context data in accordance with one or more implementations. At 902 a contact data trigger is detected to perform a contact operation. The contacts module 116, for instance, detects that a contact data trigger 202 occurs. Examples of different contact data triggers 202 are described above. According to implementations, contact data triggers can be based on events generated by different applications and can be detected across different applications. For instance, the contacts module 116 can detect contact data triggers that occur in different applications such as the messaging module 118, the calendar module 120, the social media module 122, etc.

At 904 context data is obtained pertaining to one or more of the contact data trigger or the contact operation, the context data including an indication of a contextual relationship between a user of the client device and a contact associated with the contact operation. As described above, for example, the context module 138 extracts context information in response to the contact data trigger. The context module 138 can extract the context data in different ways, such as from messaging interactions (e.g., text messaging, video messaging, emails, etc.) In at least one example the context module 138 can extract context information from a phone call, such as via voice recognition and/or from a text transcript of a phone call. Further, the context module 138 can extract context data across different applications, such as from the messaging module 118, the calendar module 120, the social media module 122, etc. For instance, context data for a contact recommendation can identify an application from which the context data is extracted.

At 906 a contact recommendation is generated based at least in part on the context data. The contacts module 116, for example, generates a contacts recommendation that includes at least some of the context data as well as other extracted information, such as a contact name, phone number, email, physical address, etc. At 908 a contact profile is configured based at least in part on the contact recommendation. The contacts module 116, for instance, generates a new contact profile 136 and/or updates an existing contact profile 136 based on the contact recommendation. Further, the configured contact profile 136 includes at least some of the extracted context information.

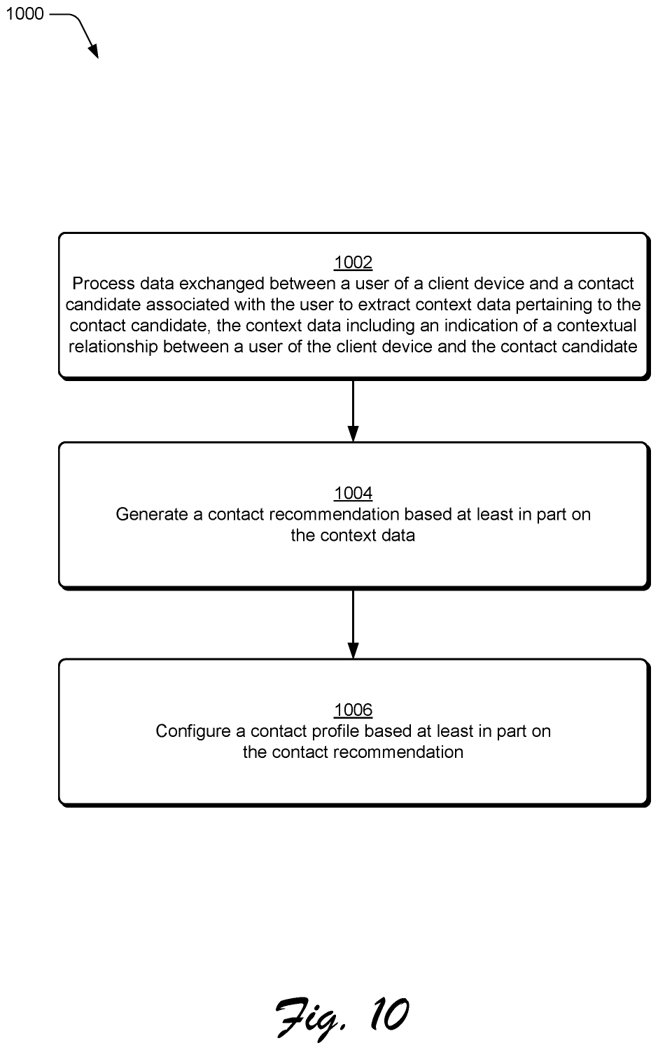

FIG. 10 illustrates a flow chart depicting an example method 1000 for contact configuration including extracted context data in accordance with one or more implementations. The method 1000, for example, represents an alternative or additional implementation to the method 900 and in at least some implementations, may be performed in conjunction with the method 900.

At 1002 data exchanged between a user of a client device and a contact candidate associated with the user is processed to extract context data pertaining to the contact candidate, the context data including an indication of a contextual relationship between a user of the client device and the contact candidate. For instance, in response to a contact data trigger 202, the contacts module 116 and/or the context module 138 process data exchanged between different users, such as part of a communication event between the users. Examples of different communication events are discussed throughout this disclosure and include different types of messaging (e.g., text, video, audio, etc.), email, phone calls, etc. Examples of the extracted context data include personal and/or professional relationship data between the different users, location data, communication intent data, calendar data, etc.

At 1004 a contact recommendation is generated based at least in part on the context data. The contacts module 116, for instance, generates a contact recommendation that includes at least some of the extracted context data. Examples of different contact recommendations are described above and illustrated in the accompanying figures. At 1006 a contact profile is configured based at least in part on the contact recommendation. A user, for instance, provides input to accept the contact recommendation, and the contacts module 116 generates a contact profile 136 based at least in part on the contact recommendation. According to implementations the contact profile 136 includes at least some of the extracted context data. For instance, when a user views the contact profile 136 at least some of the extracted context data can be included as part of the contact profile 136.

While various operations are described above with reference to the actions performed by the contacts module 116 and its associated functionality, it is to be appreciated that the described operations may alternatively or additionally be performed via the contacts service 104.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 11 illustrates various components of an example device 1100 in which aspects of contact configuration including extracted context data can be implemented. The example device 1100 can be implemented as any of the devices described with reference to the previous FIGS. 1-10, such as any type of client device, mobile phone, mobile device, wearable device, tablet, computing, communication, entertainment, gaming, media playback, and/or other type of electronic device. For example, the client device 102 as shown and described with reference to FIGS. 1-10 may be implemented as the example device 1100.

The device 1100 includes communication transceivers 1102 that enable wired and/or wireless communication of device data 1104 with other devices. The device data 1104 can include any of device identifying data, device location data, wireless connectivity data, and wireless protocol data. Additionally, the device data 1104 can include any type of audio, video, and/or image data. Example communication transceivers 1102 include wireless personal area network (WPAN) radios compliant with various IEEE 802.15 (Bluetooth™) standards, wireless local area network (WLAN) radios compliant with any of the various IEEE 802.7 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 1100 may also include one or more data input ports 1106 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 1100 includes a processing system 1108 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 1110. The device 1100 may further include any type of a system bus or other data and command transfer system that couples the various components within the device. A system bus can include any one or combination of different bus structures and architectures, as well as control and data lines.

The device 1100 also includes computer-readable storage memory 1112 (e.g., memory devices) that enable data storage, such as data storage devices that can be accessed by a computing device, and that provide persistent storage of data and executable instructions (e.g., software applications, programs, functions, and the like).

Examples of the computer-readable storage memory 1112 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 1100 may also include a mass storage media device.

The computer-readable storage memory 1112 provides data storage mechanisms to store the device data 1104, other types of information and/or data, and various device applications 1114 (e.g., software applications). For example, an operating system 1116 can be maintained as software instructions with a memory device and executed by the processing system 1108. The device applications may also include a device manager, such as any form of a control application, software application, signal-processing and control module, code that is native to a particular device, a hardware abstraction layer for a particular device, and so on. Computer-readable storage memory 1112 represents media and/or devices that enable persistent and/or non-transitory storage of information in contrast to mere signal transmission, carrier waves, or signals per se. Computer-readable storage memory 1112 do not include signals per se or transitory signals.

In this example, the device 1100 includes a contacts module 1118 and a contacts module 1120 that can implement aspects of contact configuration including extracted context data and may be implemented with hardware components and/or in software as one of the device applications 1114. For example, the contacts module 1118 can be implemented as the contacts module 116 and the context module 1120 can be implemented as the context module 138. In implementations, the contacts module 1118 and/or the context module 1120 may include independent processing, memory, and logic components as a computing and/or electronic device integrated with the device 1100.

In this example, the example device 1100 also includes a camera 1122 and motion sensors 1124, such as may be implemented in an inertial measurement unit (IMU). The motion sensors 1124 can be implemented with various sensors, such as a gyroscope, an accelerometer, and/or other types of motion sensors to sense motion of the device. The various motion sensors 1124 may also be implemented as components of an inertial measurement unit in the device.

The device 1100 also includes a wireless module 1126, which is representative of functionality to perform various wireless communication tasks. For instance, for the client device 102, the wireless module 1126 can be leveraged to scan for and detect wireless networks, as well as negotiate wireless connectivity to wireless networks for the client device 102. The device 1100 can also include one or more power sources 1128, such as when the device is implemented as a mobile device. The power sources 1128 may include a charging and/or power system, and can be implemented as a flexible strip battery, a rechargeable battery, a charged super-capacitor, and/or any other type of active or passive power source.

The device 1100 also includes an audio and/or video processing system 1130 that generates audio data for an audio system 1132 and/or generates display data for a display system 1134. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 1136. In implementations, the audio system and/or the display system are integrated components of the example device. Alternatively, the audio system and/or the display system are external, peripheral components to the example device.

Although implementations of contact configuration including extracted context data have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In addition to the previously described methods, any one or more of the following:

In some aspects, the techniques described herein relate to a client device including: one or more modules implementable at least in part in hardware of the client device to: detect a contact data trigger to perform a contact operation; obtain context data pertaining to one or more of the contact data trigger or the contact operation, the context data including an indication of a contextual relationship between a user of the client device and a contact associated with the contact operation; generate a contact recommendation based at least in part on the context data; and configure a contact profile based at least in part on the contact recommendation.

In some aspects, the techniques described herein relate to a client device, wherein the contact data trigger includes a communication from a contact associated with the contact profile.

In some aspects, the techniques described herein relate to a client device, wherein the one or more modules are implementable by the client device to obtain the context data via text extraction from a communication from a contact associated with the contact profile.

In some aspects, the techniques described herein relate to a client device, wherein the communication includes a text message, and wherein the one or more modules are implementable by the client device to extract the context data from text of the text message.

In some aspects, the techniques described herein relate to a client device, wherein the communication includes a voice call, and wherein the one or more modules are implementable by the client device to extract the context data from one or more of voice data of the voice call or a text transcript of the voice call.

In some aspects, the techniques described herein relate to a client device, wherein the contextual relationship includes one or more of an indication of a personal relationship, a professional relationship, location information, or message intent data associated with a communication between the user of the client device and a contact associated with the contact operation.

In some aspects, the techniques described herein relate to a client device, wherein the one or more modules are implementable by the client device to obtain the context data via a determination of a location of the client device when the contact data trigger occurs.

In some aspects, the techniques described herein relate to a client device, wherein the one or more modules are implementable by the client device to obtain the context data via a determination of an application via which the context data is obtained.

In some aspects, the techniques described herein relate to a client device, wherein the one or more modules are implementable by the client device to tag the context data with a date on which the context data is extracted.

In some aspects, the techniques described herein relate to a client device, wherein the one or more modules are implementable by the client device to configure the contact profile to include at least some of the context data.

In some aspects, the techniques described herein relate to a system including: one or more modules implementable at least in part in hardware of the system to cause the system to: process data exchanged between a user of a client device and a contact candidate associated with the user to extract context data pertaining to the contact candidate, the context data including an indication of a contextual relationship between a user of the client device and the contact candidate; generate a contact recommendation based at least in part on the context data; and configure a contact profile based at least in part on the contact recommendation.

In some aspects, the techniques described herein relate to a system, wherein the data exchanged between the user of the client device and the contact candidate includes a messaging interaction between the user of the client device and the contact candidate.

In some aspects, the techniques described herein relate to a system, wherein the contextual relationship includes one or more of an indication of a personal relationship, a professional relationship, location information, or message intent data associated with a communication between the user of the client device and the contact candidate.

In some aspects, the techniques described herein relate to a system, wherein the contextual relationship includes one or more of an indication of a personal relationship, a professional relationship, location information, or message intent data associated with a communication between the user of the client device and the contact candidate.

In some aspects, the techniques described herein relate to a system, wherein the one or more modules are implementable by the system to tag the context data with a date on which the context data is extracted.

In some aspects, the techniques described herein relate to a system, wherein the one or more modules are implementable by the system to tag the context data based at least in part on an application via which the data is exchanged between the user of a client device and the contact candidate.

In some aspects, the techniques described herein relate to a method, including: detecting a contact data trigger to perform a contact operation; obtaining context data pertaining to one or more of the contact data trigger or the contact operation, the context data including an indication of a contextual relationship between a user of a client device and a contact associated with the contact operation; generating a contact recommendation based at least in part on the context data; and configuring a contact profile based at least in part on the contact recommendation.

In some aspects, the techniques described herein relate to a method, wherein the contextual relationship includes one or more of an indication of a personal relationship, a professional relationship, location information, or message intent data associated with a communication between the user of the client device and a contact associated with the contact operation.

In some aspects, the techniques described herein relate to a method, wherein the context data includes an indication of a location of the client device when the contact data trigger occurs.

In some aspects, the techniques described herein relate to a method, wherein configuring the contact profile includes at least some of the context data.

1. A client device comprising:
one or more modules implementable at least in part in hardware of the client device to:
detect a contact data trigger to perform a contact operation;
obtain context data pertaining to one or more of the contact data trigger or the contact operation, the context data including an indication of a contextual relationship between a user of the client device and a contact associated with the contact operation;
generate a contact recommendation based at least in part on the context data; and
configure a contact profile based at least in part on the contact recommendation.

2. The client device of claim 1, wherein the contact data trigger comprises a communication from a contact associated with the contact profile.

3. The client device of claim 1, wherein the one or more modules are implementable by the client device to obtain the context data via text extraction from a communication from a contact associated with the contact profile.

4. The client device of claim 3, wherein the communication comprises a text message, and wherein the one or more modules are implementable by the client device to extract the context data from text of the text message.

5. The client device of claim 3, wherein the communication comprises a voice call, and wherein the one or more modules are implementable by the client device to extract the context data from one or more of voice data of the voice call or a text transcript of the voice call.

6. The client device of claim 1, wherein the contextual relationship comprises one or more of an indication of a personal relationship, a professional relationship, location information, or message intent data associated with a communication between the user of the client device and a contact associated with the contact operation.

7. The client device of claim 1, wherein the one or more modules are implementable by the client device to obtain the context data via a determination of a location of the client device when the contact data trigger occurs.

8. The client device of claim 1, wherein the one or more modules are implementable by the client device to obtain the context data via a determination of an application via which the context data is obtained.

9. The client device of claim 1, wherein the one or more modules are implementable by the client device to tag the context data with a date on which the context data is extracted.

10. The client device of claim 1, wherein the one or more modules are implementable by the client device to configure the contact profile to include at least some of the context data.

11. A system comprising:
one or more modules implementable at least in part in hardware of the system to cause the system to:
process data exchanged between a user of a client device and a contact candidate associated with the user to extract context data pertaining to the contact candidate, the context data including an indication of a contextual relationship between a user of the client device and the contact candidate;
generate a contact recommendation based at least in part on the context data; and
configure a contact profile based at least in part on the contact recommendation.

12. The system of claim 11, wherein the data exchanged between the user of the client device and the contact candidate comprises a messaging interaction between the user of the client device and the contact candidate.

13. The system of claim 11, wherein the contextual relationship comprises one or more of an indication of a personal relationship, a professional relationship, location information, or message intent data associated with a communication between the user of the client device and the contact candidate.

14. The system of claim 11, wherein the contextual relationship comprises one or more of an indication of a personal relationship, a professional relationship, location information, or message intent data associated with a communication between the user of the client device and the contact candidate.

15. The system of claim 11, wherein the one or more modules are implementable by the system to tag the context data with a date on which the context data is extracted.

16. The system of claim 11, wherein the one or more modules are implementable by the system to tag the context data based at least in part on an application via which the data is exchanged between the user of a client device and the contact candidate.

17. A method, comprising:
detecting a contact data trigger to perform a contact operation;
obtaining context data pertaining to one or more of the contact data trigger or the contact operation, the context data including an indication of a contextual relationship between a user of a client device and a contact associated with the contact operation;
generating a contact recommendation based at least in part on the context data; and
configuring a contact profile based at least in part on the contact recommendation.

18. The method of claim 17, wherein the contextual relationship comprises one or more of an indication of a personal relationship, a professional relationship, location information, or message intent data associated with a communication between the user of the client device and a contact associated with the contact operation.

19. The method of claim 17, wherein the context data comprises an indication of a location of the client device when the contact data trigger occurs.

20. The method of claim 17, wherein configuring the contact profile includes at least some of the context data.
